(19) United States
(12) Patent Application Publication
(10) Pub. No.: US 2016/0344751 A1
(43) Pub. Date: Nov. 24, 2016

(54) CUSTOMIZED RECORD HANDLING IN A CONTENT DELIVERY NETWORK

(71) Applicant: Fastly, Inc., San Francisco, CA (US)

(72) Inventor: Sean Leach, Castle Pines, CO (US)

(21) Appl. No.: 14/716,110

(22) Filed: May 19, 2015

(51) Int. Cl. H04L 29/06; G06Q 30/04; H04L 29/08

(52) U.S. Cl. CPC H04L 63/1416; H04L 67/1097; G06Q 30/04

(57) ABSTRACT

Systems, methods, apparatus and software for customized record handling in a content delivery network are disclosed. In one implementation, a user request received by the content delivery network is analyzed and classified. Records relating to the received user request are customized based on the request classification. Record customization is implemented in some examples to reduce data storage and/or processing requirements in the content delivery network. Moreover, request-based records can be used to implement specified functions, such as billing content providers only for bona fide user requests.

### TECHNICAL FIELD

Aspects of the disclosure are related to the field of data transfer, and in particular are related to user requests directed to one or more content delivery network cache nodes and customized request-based record handling relating to such requests.

### TECHNICAL BACKGROUND

Network-provided content (e.g., Internet web pages or media content such as video, pictures, music, and the like) are typically delivered to end users via networked computer systems. End user requests for the network content are processed and the content is responsively sent to users over various network links. These networked computer systems can include origin hosting servers (e.g., web servers for hosting a news website) that host original network content of providers (e.g., creators and/or originators).

Content delivery networks have been developed to add a layer of caching between content providers' origin servers and end users. A content delivery network (CDN) typically has one or more cache nodes distributed across a geographic region to provide faster (i.e., lower latency) content access for end users. When end users request content, such as a web page, such a request is handled through a cache node that is configured to respond to end user requests (instead of having origin servers respond to such requests). Origin servers' content can be cached into each of a number of cache nodes. In this way a cache node acts as a proxy for origin servers.

Malicious attacks of websites and/or CDNs are a threat to businesses worldwide and can undermine legitimate use of a CDN by bona fide users and content providers. Such attacks can incapacitate a targeted business, thus inflicting monetary and perhaps other damage on the victim(s). One type of network attack referred to as a denial of service (DoS) attack can paralyze systems by overwhelming servers, network links, and network devices with bogus traffic. These and other forms of attacks not only target specific websites and/or servers at a network's edge, they also can disrupt the network itself.

### Overview

Systems, methods, apparatus and software for customizing record handling in a content delivery network are disclosed. In some implementations, a method of operating a content delivery network (“CDN”) generates customizable records based on the classification of received user requests. User requests received by a content delivery network are analyzed and classified. Records relating to the received request and data associated therewith (for example, logs and other CDN records) are customized based on the category to which the received request is assigned. In some implementations, a given request is classified as either a bona fide request (a first category) or an attack-related request (a second category). One or more customized logs and/or other records relating to the received request are generated depending on the category to which the request is assigned. Each category's type of log entry implements a data profile that specifies the type of data generated relating to each category's requests. For example, thorough and/or robust log entries and/or records can be generated for bona fide requests (i.e., a first data profile for user requests assigned to the first category), while abridged log entries and other records are generated for attack-related requests (i.e., a second data profile for user requests assigned to the second category). In some situations, a content provider or other party may receive records-based communications from the CDN that reflect the customized CDN record handling (e.g., a content provider might be billed only for bona fide requests while not being billed at all for attack-related requests).

In other implementations, a plurality of categories are used to classify one or more received requests. The category to which each received request is assigned dictates the type of CDN log entry (and/or other CDN record) that is created relating to that received request. Additional records that might be generated concerning the received requests) likewise can be customized accordingly. Moreover, selected operations may be performed by the CDN based on the request's classification.

In various other implementations, the analysis and classification of received requests can be performed at different points in the CDN's request processing.

### BRIEF DESCRIPTION OF THE DRAWINGS

Many aspects of the disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the views. While multiple implementations are described in connection with these drawings, the disclosure is not limited to the implementations disclosed herein. On the contrary, the intent is to cover all alternatives, modifications, and equivalents.

FIG. 1 illustrates a communication system.

FIG. 2 illustrates a method of operation of a content delivery system.

FIG. 3A is a sequence diagram illustrating an exemplary method of operating a communication system.

FIG. 3B is a sequence diagram illustrating an exemplary method of operating a communication system.

FIG. 4 illustrates a communication system.

FIG. 5 illustrates a method of operation of a content delivery system.

FIG. 6 is a sequence diagram illustrating an exemplary method of operating a communication system.

FIG. 7 illustrates a communication system.

### DETAILED DESCRIPTION

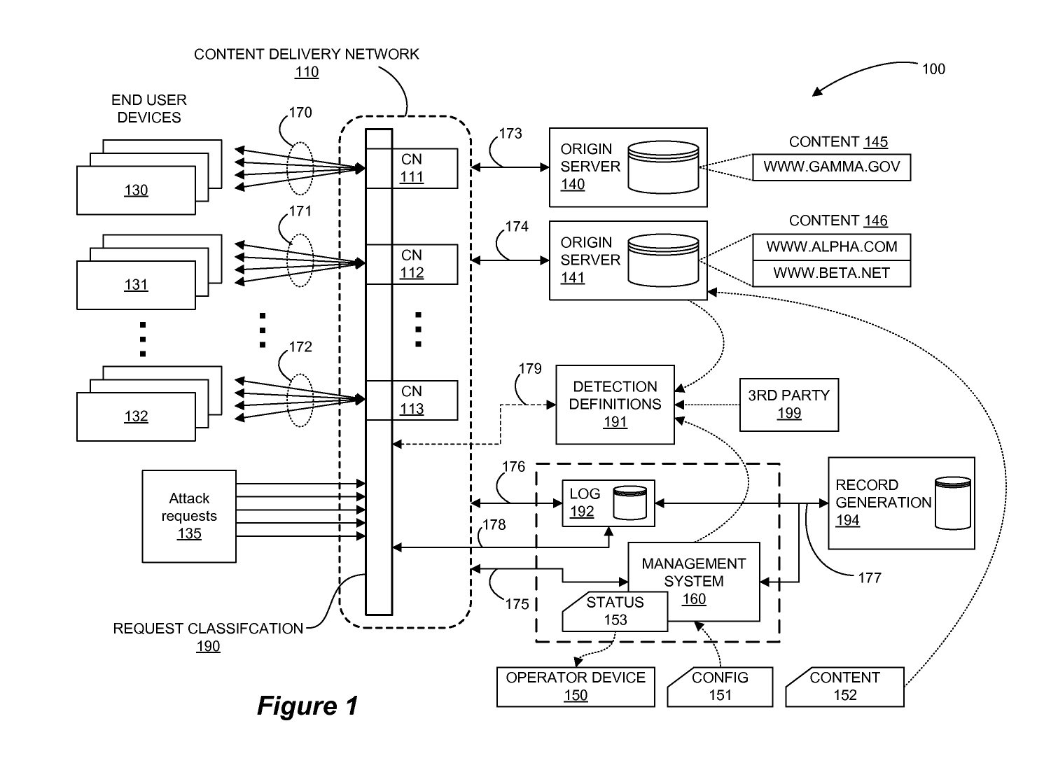

Network content, such as web page content, typically includes text, hypertext markup language (HTML) pages, pictures, video, audio, code, scripts, and/or other content viewable in an end user's browser or other application. This network content can be stored and served by origin servers and equipment. Examples of website content are referenced in FIG. 1, such as “www.gamma gov,” “www.alpha.com,” and “www.beta.net,” among others. When a content delivery network (CDN) is employed, as shown in FIG. 1, the CDN acts as a proxy to cache content delivery between origin servers and end user devices so that origin servers are not required to serve content directly to end user devices. When end users request content, such as a web page, a CDN cache node responds to the user request instead of the associated origin server (e.g., using domain name system (DNS) registration and lookup procedures to associate origin servers' web content with the cache nodes' network addresses rather than the origin servers' network addresses).

As part of a given CDN's operations, various data can be collected to facilitate monitoring, logging, alerts, billing, user profiling, management and other operational and administrative functions associated with operating the CDN. Such operational and administrative functions in earlier content delivery systems relied upon logged activity data collected from the CDN. Various data collection systems and the like have been used to collect usage data and other data from edge servers, aggregating such data across one or more geographic and/or logic regions of a given network. That collected data is then used by the above-noted operational and administrative functions, systems and the like. Such earlier systems collected and stored the same types of data relating to all user requests and then sorted, evaluated, analyzed, etc. the already-logged data.

Content providers (e.g., media companies, e-commerce vendors, etc.) pay CDN operators to deliver content to end-users via internes service providers, carriers and network operators who are paid by the CDN to host servers in their data centers. CDNs provide better speed, availability and performance, while also offloading traffic that would otherwise be served directly by content providers, thus saving content providers the cost of handling all such traffic alone. In addition to reducing content providers' costs, CDNs can provide a buffer and/or protection from attacks and/or other malicious activities by using a CDN's distributed server infrastructure to detect, absorb, diffuse, etc. attack traffic such as denial of service “DoS” and “slow DoS” attacks that attempt to overwhelm, slow down or force failure of targeted servers.

FIG. 1 illustrates an exemplary content delivery system 100. System 100 includes content delivery network (CDN) 110, end user devices 130-132, origin servers 140-141, management system 160, request classification unit 190 (e.g., implemented as a service and/or a module), log 192, and record generation unit 194 (e.g., again implemented as a service and/or a module). Content delivery network 110 includes one or more cache nodes (CNs) 111-113, each of which can include suitable processing resources and one or more data storage systems. End user devices 130-132 are representative of a plurality of end user communication devices that can request and receive content from CNs 111-113 of network 110 using associated links 170-172. The transfer of content from CDN 110 to a given user device is initiated when a specific user device associated with a given cache node 111-113 transmits a request to its corresponding cache node (any number of end user devices 130-132 can be associated a single cache node).

Content delivery network 110 communicates with origin servers 140-141 using associated links 173-174. Other network components likewise communicate over appropriate links. Content delivery network 110 and management system 160 communicate over link 175. Likewise CDN 110 and log 192 communicate over link 176. Request classification unit 190 communicates with CDN 110 (and, in some examples, record generation system 194) using communication link 178. Log 192 and/or management system 160 also can communicate with record generation unit 194 via link 177. Each CN 111-113 communicates with each other CN over CDN network links.

Management system 160 collects and delivers various administrative and other data such as configuration changes and status information for various parties (e.g., system operators, origin server operators, managers and the like). For example, operator device 150 can transfer configuration data 151 for delivery to management system 160 and/or request classification unit 190, where configuration data 151 can alter the handling of network content requests by CNs 111-113, among other operations. Also, management system 160 can monitor status information for the operation of CNs 111-113, such as operational statistics, and provide status information 153 to operator device 150. Furthermore, operator device 150 can transfer content 152 for delivery to origin servers 140-141 to include in content 145-146. Although one operator device 150 is shown in FIG. 1, it should be understood that this is merely representative and communication system 100 can include many operator devices for receiving status information, providing configuration information, or transferring content to origin servers.

Regarding a first illustrative implementation of customized record handling in a content delivery network based on user request classification, FIG. 1 illustrates the use of a request classification unit 190 that detects, analyzes and classifies incoming user requests as part of the operation of CDN 110. In FIG. 1, unit 190 is configured (e.g., as a service, a module, or the like) to evaluate whether requests to cache nodes 111-113 are attack-related requests (for example, from one or more attack request sources 135) or are bona fide user requests from user devices 130-132 (as is well known, attack requests and other attack-related communications also can come from authorized user devices associated with a CDN or the like).

The specific types of data generated and stored in log 192 by system 100 are based on how requests received by the CNs 111-113 are classified by request classification unit 190 (e.g., using defined categories). Each request classification category may be associated with a customizable data profile that defines the types of data that will be collected, generated, stored, etc. in connection with each received user request that is classified in that category. More specifically, in some implementations, the type of data generated and stored in log 192 is determined by each request's classification as either a “bona fide request” (a first classification category) or an “attack-related request” (a second classification category) as determined by unit 190. Management system 160 also can collect data regarding bona fide and attack-related requests in some implementations. Logged data, customized according to its associated request classification, can then be used to generate other customized records in record generation unit 194. In at least one example of the operation of the system of FIG. 1, the records generated in record generation unit 194 include billing of CDN customers such as content providers.

In many CDNs, customers are billed for each user request that is processed by the content delivery network, regardless of the source and/or nature of such requests. By using customized record handling (the logged data and/or records generated therefrom) to enhance content delivery network operation, CDNs can realize various advantages such as (1) reducing data processing and storage requirements, (2) eliminating the practice of billing content providers for attack-related and/or other bogus user requests, and in other useful ways. Other recordkeeping, administrative, operational and business functions can likewise be based on the customized logs and other customized records generated by a CDN during operation. By classifying incoming requests before performing downstream processing and storage of request-related data, content delivery system 100 can proactively determine what kind of data to log, as well as what types of records to generate and store for various classes of user requests. Such proactive determinations can reduce the data processing and storage needs of a content delivery system.

Customized data logging and record generation are preferable to earlier systems, methods, etc. that collected the same amount and type of data on all received requests and subsequent request-related network activity and transmissions, typically creating a master log in which each entry contained the same data (e.g., user identity, content provider identity, requested content type, requested content size, etc.), regardless of the request's legitimacy. The contents of these master logs were then processed and evaluated to develop more specific data and records and to perform various functions such as billing. CDN operation implementations disclosed herein avoid the need for creating such uniform master logs containing only “full” log entries and the like by proactively classifying requests so that different amounts and types of data can be collected, generated, stored and processed based on the origin, validity and/or intent of requests directed to a CDN.

In the exemplary system 100 of FIG. 1, request classification unit 190 employs detection techniques and/or definitions that can be provided by a detection definition unit 191 via link 179. Detection processes and definitions can be supplied to unit 191 by management system 160, by an origin server 141, by a third party source or service 199, and/or by any other suitable source. Such detection processes and definitions can be updated from time to time to keep pace with evolving attack schemes and other malicious behavior that is potentially disruptive of system 100. Request classification unit 190 can also provide detection and definition data to unit 191 via link 179.

Using customized request-classification-based logs and other records according to one or more implementations, when unit 190 determines that a request received by CDN 110 relates to an attack and/or other malicious activity, different logging and/or record generation is implemented (e.g., to reduce or otherwise improve data processing and storage performance). For example, more thorough data logs may be kept of legitimate user activity to facilitate building user profiles, to facilitate building browser-specific profiles, to provide detailed billing to CDN customers, to develop CDN traffic flow records, etc. Limited data logs and/or records may be appropriate for attack data, where the limited data records may maintain enough data to allow for analysis of an attack, etc. With regard to billing of CDN customers, a CDN operator can use such customized data and records to waive billing content providers for requests that are part of an attack or other malicious activity directed at the content provider.

In system 100 of FIG. 1, a request (e.g., a bona fide request from a user device 130-132 or an attack-related request from an attack request source 135) is received by CDN 110 (i.e., one of the CNs 111-113). Request classification unit 190 analyzes and classifies the request as either a bona fide request (i.e., a first category) or an attack-related request (i.e., a second category), for example using definitions and/or detection data supplied by unit 191. If the received request is classified as a bona fide request, then a full log using a bona fide request data profile is generated and stored in log 192 and appropriate record(s) developed by record generation unit 194 for that request and any subsequent CDN activity pertaining to the request. If the request received by CDN 110 is classified as an attack-related request, then an abridged log entry using an attack-related request data profile is generated and stored in log 192, and suitable customized record(s) can then be generated for that attack-related request and any subsequent CDN activity pertaining to the request.

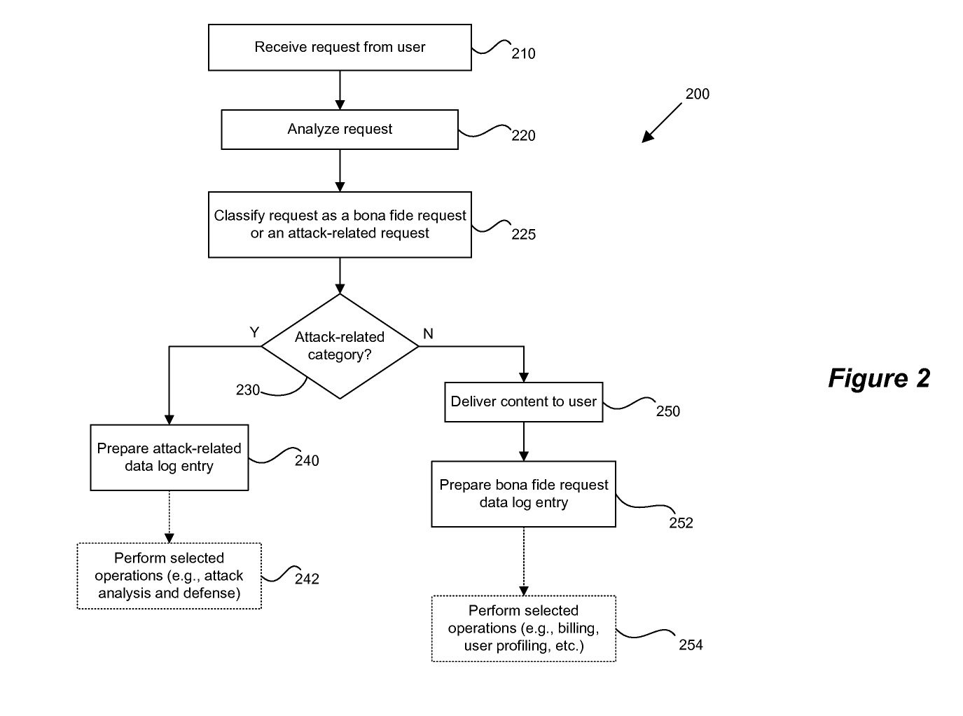

FIG. 2 illustrates one or more non-limiting examples of a method of operation 200 of a content delivery network in which the CDN receives a user request (210) that is analyzed to determine whether or not it is an attack-related request. The received request is analyzed (220), for example by a request classification unit, a cache node, or by another component of a content delivery network. Based on that analysis, the request is classified (225) as belonging in one of two categories, either a bona fide request or an attack-related request. Based on the classification decision (230), an attack-related data log entry is prepared (240) or a bona fide request data log entry is prepared (250), where each type of log entry can utilize a preselected data profile that specifies the type and amount of data to be collected and stored in order to construct the relevant (i.e., customized) log entry and any other customized request-based records.

Using one or more attack-related request log entries and any other records generated therefrom, the CDN can perform (242) selected operations such as attack analysis and defense, etc. This performance of selected operations also can include specifying how the attack-related request log entry is stored (if it all) and how that data is used. If the user request is determined to be a bona fide request, then the requested content is sent to the user (250) and a bona fide request log entry is then prepared (252). The CDN can perform (254) selected operations such as billing, user profiling, etc. Again, these selected operations can include operations that specify how and where the log entry data is stored and used.

As noted above, the two different types of log entries can be customized so that their respective data profiles differ as to contents, size, storage location, subsequent use, subsequent retention/erasure, etc. In some situations the distinction between bona fide and attack requests can be used in conducting other operational and management aspects of a content delivery network. For example, the operator of a content delivery network may decide to forego billing customers for requests that are part of an attack and/or other malicious online activity. In some implementations, customization of the log entries and other records generated therefrom can include optimizing storage utilization, log/record retention, and other factors to enhance the performance of a content delivery network.

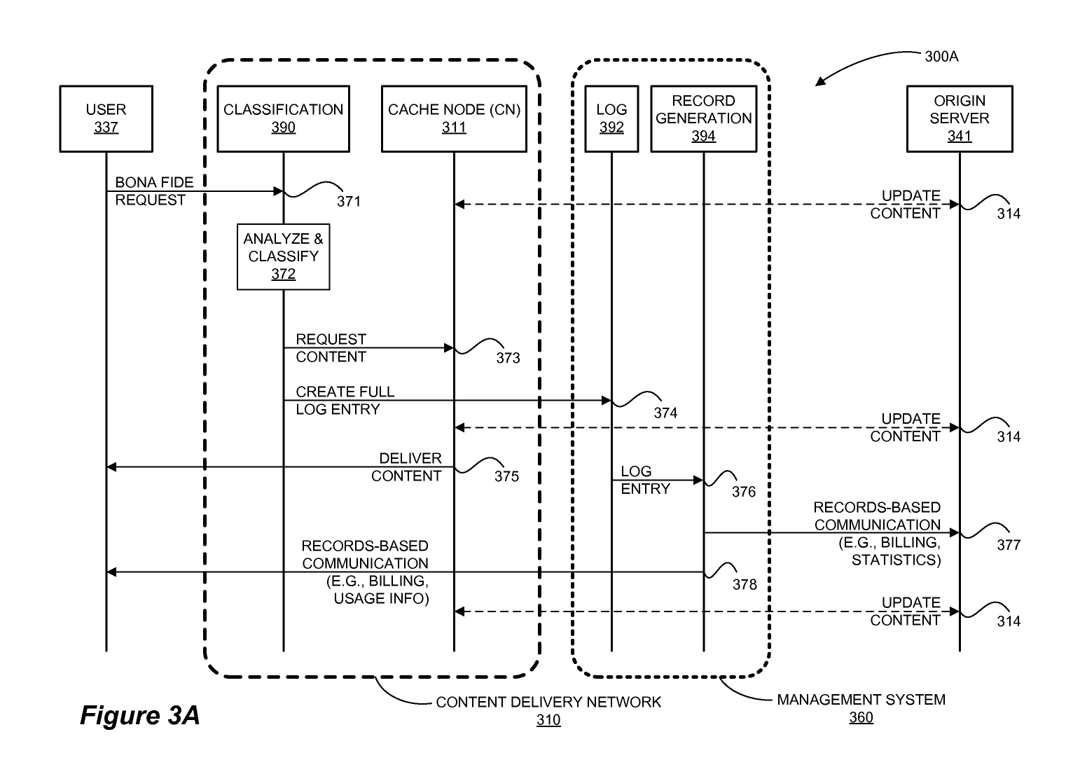

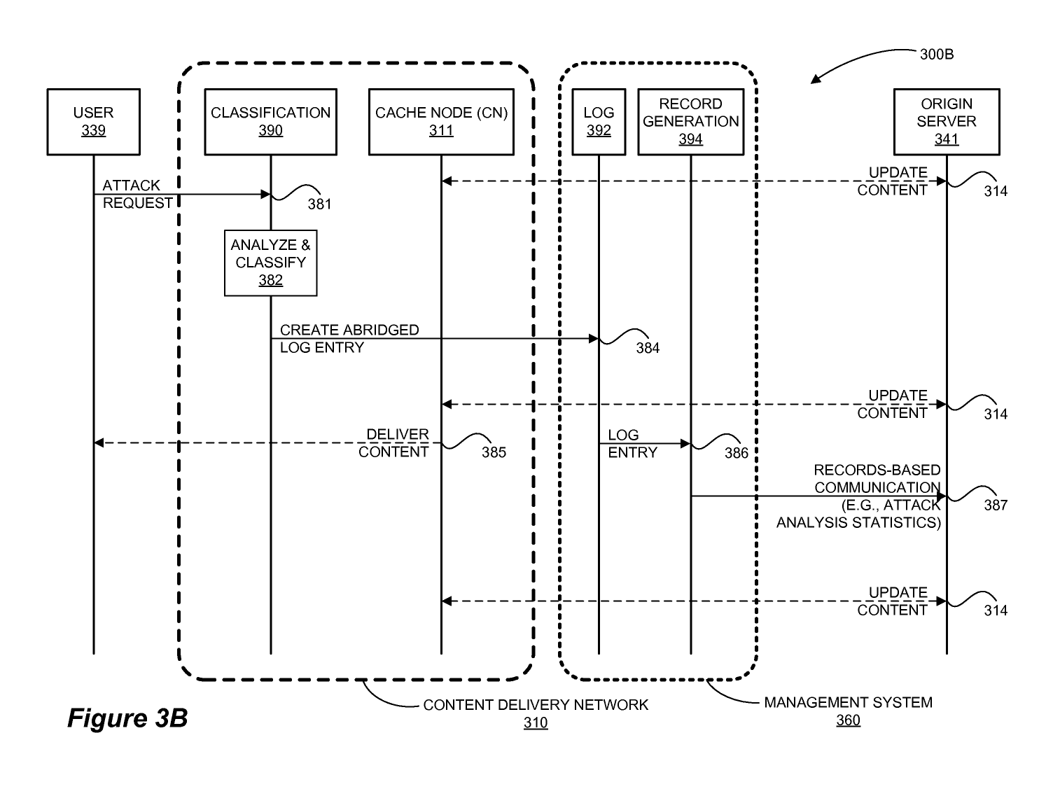

FIG. 3A is a method flow diagram illustrating aspects of one or more methods of operation 300A of a communication system. In this example, content delivery network 310 receives a bona fide request from user device 337 for content from origin server 341 (operation 371). Content delivery network 310 receives the request and classification unit 390 analyzes and classifies the request (operation 372). Because the request is categorized as a bona fide user request for content, cache node 311 receives this content request and checks to see if it has the content cached locally (operation 373). It should be noted that the request classification unit 390 can be integrated into cache node 311 so that the receipt of the content request (operation 373) by cache node 311 occurs prior to analysis and classification (operation 372). Other variations are possible in the sequencing of operations performed by method(s) of operation 300A. Periodic updates of content for cache node 311 are performed (operation 314) in the method(s) of operation of FIG. 3A, though a variety of approaches for content exchange between cache node 311 and origin server 341 are known, one or more of which can be implemented in the method(s) of operation 300A. If cache node 311 does not have the requested content, it can obtain that content or take any other action needed to address the pending content request.

Again because the user request in FIG. 3A has been deemed a bona fide request for content, a “full” or other appropriate log entry in this example is prepared at and/or sent to log 392 (operation 374). The data profile for such a “full” log entry can include any data typically required to create a record of a valid user transaction with CDN 310 in a suitable data structure. For example, such a log entry's data profile can include timestamp data, user identification data (e.g., a user device's IP address), cache node identification data (e.g., a cache node's IP address), URL identification data, content provider identification data, origin server data, content identification data, content size data and content type data. Other types of data usable in this setting can likewise be included in the log entry. Once content node 311 has the requested content, node 311 delivers the content to user 337 (operation 375).

Log 392 can supply one or more log entries to record generation unit 394 from time to time (operation 376), either on a scheduled basis, on demand, etc. These log entries permit the construction of other appropriate records relating to operation of the CDN 310. In one example a records-based communication is then sent to origin server 341 (or the owner of that server); that communication can include a billing or other record regarding the handling of the bona fide user request and the delivery of the requested content to that user. Other types of records-based communications can likewise be exchanged between the management system 360 and the content provider and/or another party. Similarly, for example, one or more records-based communications can be sent to the operator of user device 337 (operation 378) and/or other parties. Communications such as operation 378 may be delivered or used in communications between a user device operator and an ISP or other party working in concert with management system 360. (The relative timing of operation 375 and operation 376 can be adjusted and/or accomplished as desired—the depiction of FIG. 3A is not intended to define or limit specific timing and/or sequencing of the user-CN and CN-log communications.)

FIG. 3B is a method flow diagram illustrating aspects of one or more methods of operation 300B of a communication system, some of which can be implemented in connection with the method(s) of operation 300A of FIG. 3A. In this example, a request classification unit 390 in content delivery network 310 receives an attack-related request from user device 339 (operation 381). Classification unit 390 analyzes and classifies the request (operation 382). Because the request is categorized as an attack-related request, cache node 311 is not asked to deliver content to the user from whom the request originated. (Again, as with the method 300A of FIG. 3, periodic updates of content for cache node 311 can be performed (operation 314) and request classification unit 390 may be combined with cache node 311). If the analysis and classification of the incoming request cannot be performed prior to finding and delivering content to the user 339 from whom the attack-related request originated, that content delivery (optional operation 385) might be performed in some cases.

Because the user request has been deemed an attack-related request in this situation, an abridged (or otherwise customized) log entry is prepared at or sent to log 392 (operation 384). The data profile for such an “abridged” log entry can include only that data required to create a record of an attack against CDN 310, origin server 341, etc. For example, such an abridged log entry can contain the user device identification data, cache node identification data, data regarding the origin server to which the attack request was directed, and data pertaining to one or more timestamps. Other types of data usable in this setting can likewise be included in the log entry. In other examples the system may forego any log entry at all; the abridged log entry in such an example would be the absence of a log entry for the attack-related request.

Log 392 can supply one or more abridged log entries to record generation unit 394 from time to time (operation 386). These log entries permit the construction of appropriate records relating to attacks and/or other malicious activity involving CDN 310. In one example a records-based communication is then sent to origin server 341 (or the owner of that server); that communication can be statistics usable in analyzing the attack. In some examples, where content providers are not billed for attack requests, the content provider might nevertheless receive a records-based communication from the operator of CDN 310 advising the content provider of the requests for which the provider has not been billed plus any other relevant data.

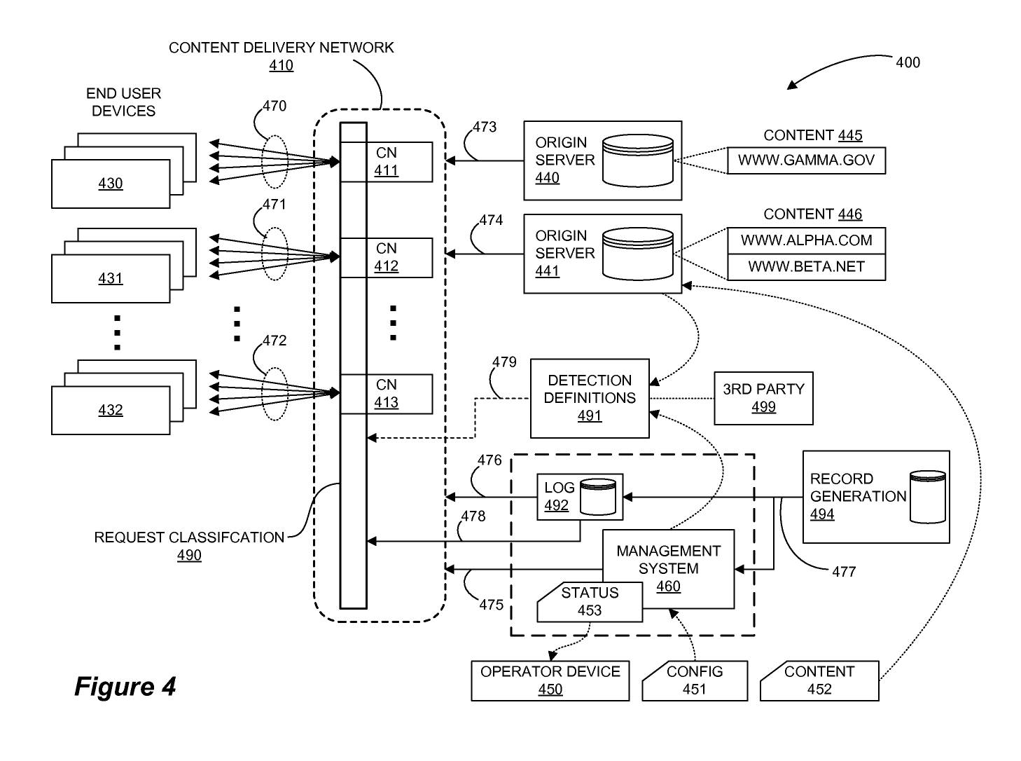

FIGS. 4-6 illustrate one or more alternative implementations of customized record handling in a content delivery network that utilize request classification to customize log entries and other records based on the type of request received by a content delivery network. The classification of user requests described above utilizing two categories—bona fide user requests and attack requests—can be expanded to permit classification of incoming user requests and associated customized record handling for other purposes as well. For example, records can be customized to reflect the status or classification of one or more users who send requests to a content delivery network or the like. Classification may also be based, in whole or in part, on other factors (e.g., the content sought and the nature of the request).

FIG. 4 illustrates one or more implementations of a content delivery system 400 that includes content delivery network (CDN) 410, end user devices 430-432, origin servers 440-441, management system 460, request classification unit 490 (e.g., implemented as a service and/or a module), log 492, and record generation unit 494 (e.g., again implemented as a service and/or a module). Content delivery network 410 includes one or more cache nodes (CNs) 411-413, each of which can include suitable processing resources and one or more data storage systems. End user devices 430-432 are representative of a plurality of end user communication devices that can request and receive content from network 410. Again, transfer of content from CDN 410 to a given user device is initiated when the user device transmits a request to a cache node 411-413 and any number of end user devices 430-432 can be associated with each cache node 411-413 (communicating over network links 470-472). Content delivery network 410 communicates with origin servers 440-441 over network links 473-474 and with management system 460 over link 475. Likewise CDN 410 communicates with log 492 over link 476 and with CDN 410 (and, in some examples, record generation system 494) using link 478. Log 492 and/or management system 460 also can communicate with record generation unit 494 via link 477. Each CN 411-413 communicates with each other CN over CDN network links.

Management system 460 collects and delivers various administrative and other data, for example configuration changes and status information for various parties (e.g., system operators, origin server operators, managers and the like) and can function (along with origin servers 440-441, operator device 450, configuration data 451, content 452, status information 453 and content 445-446) in much the same way as described above with regard to management system 160 in FIG. 1.

Illustrating another example of request-based customized record handling (e.g., optimization) in a content delivery network based on user request classification, FIG. 4 illustrates use of a request classification unit 490 that detects, analyzes and classifies incoming user requests as part of the operation of CDN 410. Unit 490 is configured to analyze requests directed to cache nodes 411-413 and to classify each such request using a classification scheme that has a plurality of categories (e.g., Category 1, Category 2, Category 3, etc.). Depending on the category to which a given user request is assigned, a classification-based log entry is generated (e.g., using an appropriate classification-based data profile) and stored in log 492; the classification categories can be based on one or more factors (e.g., type of user, user device, request origin, IP address, user subscription status, number of requests received from a given user during a given time period, etc.). For example, where a user's subscription status is used, Category 1 may designate a user who has a premium subscription, Category 2 a user with a basic subscription, and Category 3 a non-subscribing user.

Again, as with system 100 above, any record(s) generated by record generation unit 494 can be customized (e.g., optimized, limited and/or otherwise defined) on the basis of the user request's classification. For purposes of illustration, using the example noted above, various users may have different subscriptions to a given website, ISP, CDN or other location/system. If a user is a “premium” subscriber, then that user might have paid for privacy that avoids the need for generating specific types of log data (e.g., data used in connection with targeted online advertising), or the premium subscription user may have already provided sufficient profile data to avoid the need for performing user profiling or other data mining, thus reducing the amount and types of data that need to be collected during CDN operations.

Data pertaining to requests received by CDN 410 can be used to generate logs stored by log 492 using request classification information provided by request classification unit 490 and/or CDN 410, where the type and amount of data (e.g., according to a specified data profile) logged by log 492 is determined by the category to which each request is assigned by unit 490. Management system 460 also can collect data regarding various request categories in some examples. Collected data logs are then used to generate additional records in record generation unit 494. In at least one example of the operation of the system of FIG. 4, the records generated in record generation unit 494 are used to determine billing of CDN customers such as content providers. In many CDNs customers are billed for each user request that is processed by the content delivery network, regardless of the source and/or nature of such requests.

By using customized content delivery network records as taught and disclosed herein, CDNs can reduce data processing and storage requirements. In some implementations, such customized records can be used to eliminate the practice of billing content providers for bogus user requests and in other useful ways. Other recordkeeping, administrative, operational and business functions can likewise be based on the logs and other records generated by a CDN during operation. By classifying incoming requests before performing downstream processing and storage, content delivery system 400 can proactively determine what types of records should be generated and stored for various classes of user requests. Such proactive determinations can reduce the data processing and storage needs of system 400.

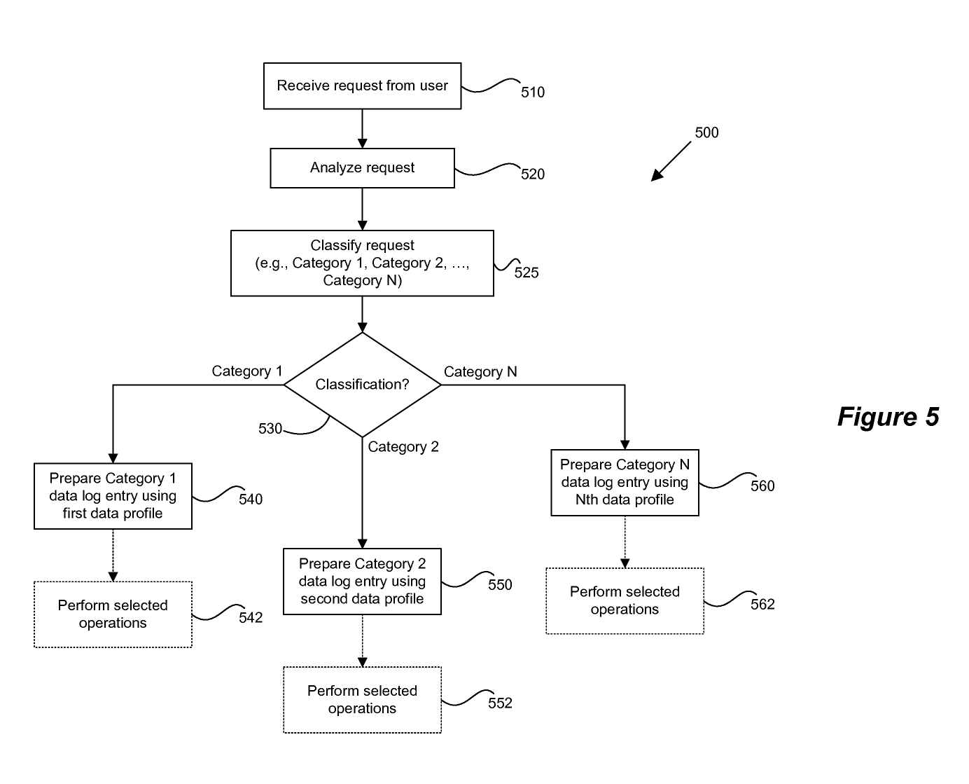

FIG. 5 illustrates another example of one or more methods of operation 500 of a content delivery network in which the CDN receives a user request (510). The received request is analyzed (520). Using that analysis the request is classified (525) using two or more categories. Based on the classification decision (530), a category-based log entry is prepared (one of 540, 550, 560). Using the category-based log entry, the CDN can perform (one of 542, 552, 562) selected operations such as record customization, optimization, analysis, billing, user profiling, etc. As noted above, different types of log entries can differ as to data profile, contents, size, storage location, subsequent use, subsequent data retention/erasure, etc.

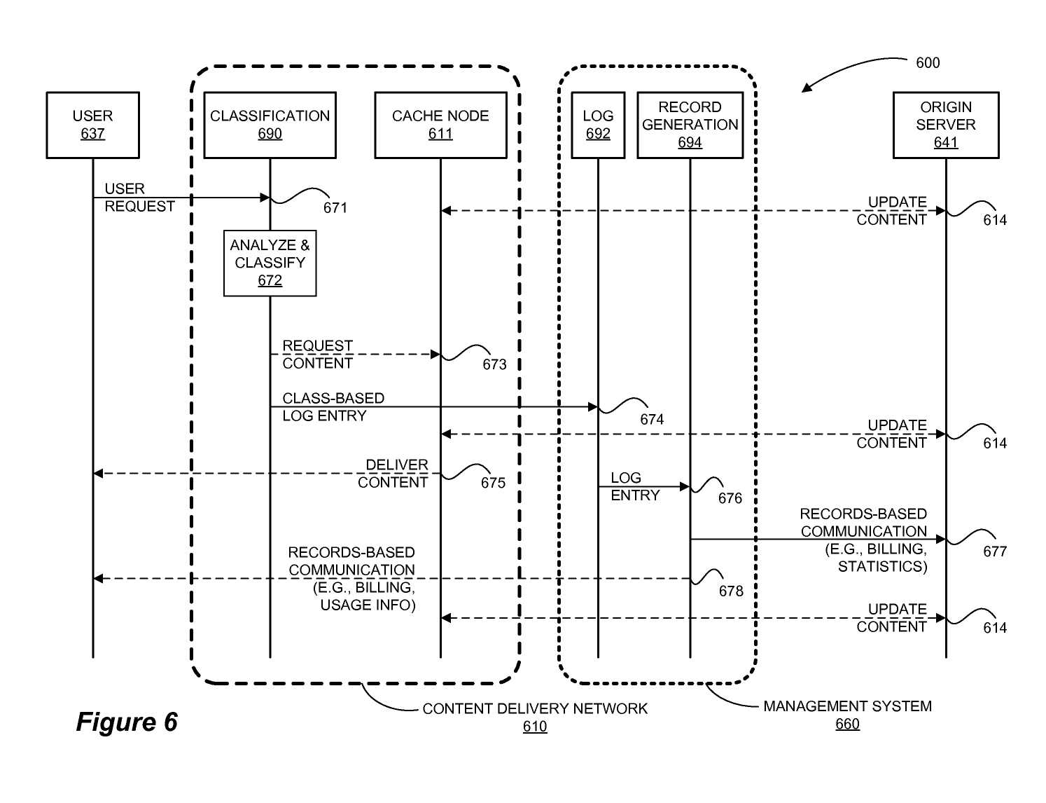

FIG. 6 is a method flow diagram illustrating aspects of one or more methods of operation 600 of a communication system. In this example, content delivery network 610 receives a user request from user device 637 for content from origin server 641 (operation 671). Content delivery network 610 receives the request and request classification unit 690 analyzes and classifies the request (operation 672). Classification can include denoting a given user request as belonging to one of a plurality of classes implemented by method(s) of operation 600.

When the request is a bona fide user request for content, cache node 611 receives this content request and checks to see if it has the content cached locally (operation 673); in some cases, however, operation 673 might not take place. Periodic updates of content for cache node 611 are performed (operation 614) in the method of FIG. 6, though a variety of approaches for content exchange between cache node 611 and origin server 641 are known, one or more of which could be implemented in method of operation 600. If cache node 611 does not have the requested content, it can obtain that content or take any other action needed to address the pending content request.

A classification-based log entry is prepared at or sent to log 692 (operation 674). Such a log entry can include any data using a data profile typically required to create a record of a user transaction consistent with the determined request category in CDN 610. For example, such a log entry can contain the user device IP address, the cache node IP address, the origin server from which the requested content was obtained, one or more timestamps, and the size and nature of the requested content. Other types of data usable in this setting can likewise be included in the log entry. Once content node 611 has any requested content, node 611 can deliver the content to user 637 (operation 675); again, this operation might not take place in all implementations.

Log 692 can supply one or more log entries to record generation unit 694 from time to time (operation 676). These log entries permit the construction of appropriate records relating to operation of the CDN 610—such records construction can be implemented to customize such records in various ways (e.g., optimizing data storage usage, limiting log and/or record content, by limiting log and/or record size, by limiting log and/or record duration prior to deletion, etc.). A records-based communication can then be sent to origin server 641 (or the owner of that server); that communication can be billing for the handling of the user request and the delivery of the requested content to that user. Other types of records-based communications can likewise be exchanged between the management system 660 and the content provider. Similarly, one or more records-based communications can be sent to the operator of user device 637 (operation 678) and/or other parties. Communications such as operation 678 may be delivered or used in communications between a user device operator and an ISP or other party working in concert with management system 660. (The relative timing of operation 675 and operation 676 can be adjusted and/or accomplished as desired—the depiction of FIG. 6 is not intended to be restrictive or limiting in defining specific timing and/or sequencing of the user-CN and CN-log communications.)

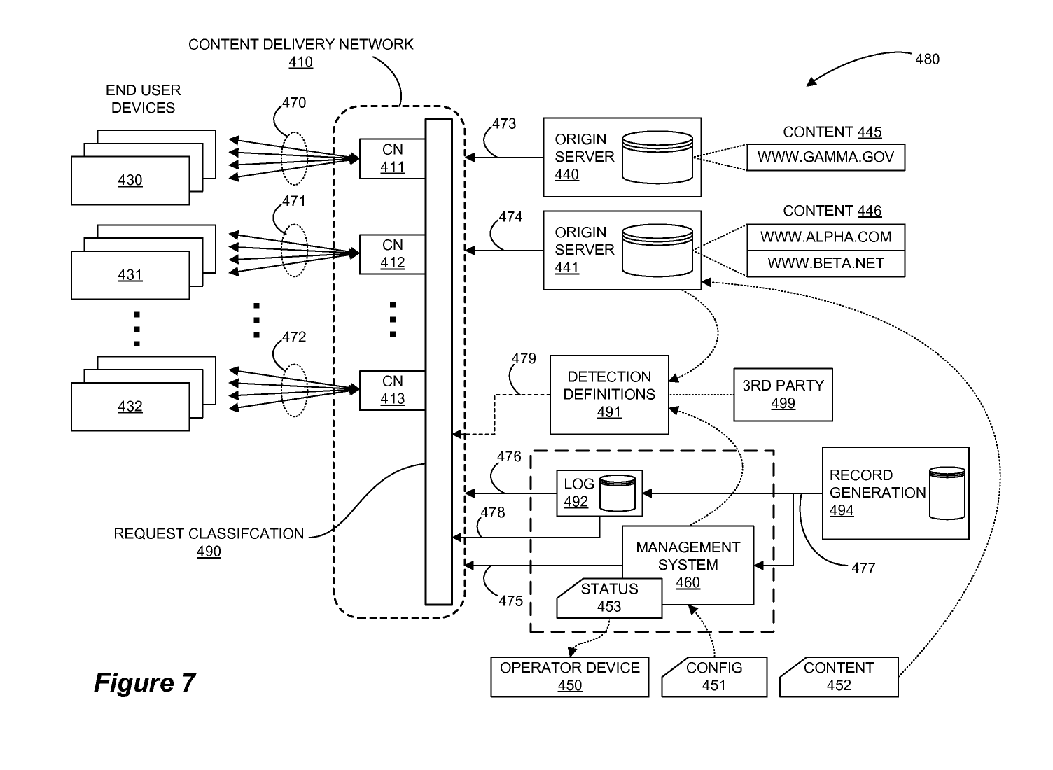

In other examples, request classification (e.g., determining whether a user request is an attack-related request) can be performed at a different point in the processing of the request by a CDN or the like. As seen in FIG. 7, which illustrates a variation 480 of the system of FIG. 4, the request classification unit 490 may receive a user request after the request has already been at least partially processed (e.g., after a request for content has been sent to a cache node, after content has been delivered from an origin server to a cache node, etc.). In such cases, records customization of logs and other records can proceed as noted above with any necessary adjustments required due to the analysis and classification being performed at a more downstream point in the request processing.

The included description(s) and figures depict various implementations to teach those skilled in the art how to make and use the best mode. For the purpose of teaching inventive principles, some conventional aspects have been simplified or omitted. Those skilled in the art will appreciate variations from these exemplary implementations that fall within the scope of the invention. Various technical effects will be appreciated based on the foregoing—for example, reduced or otherwise improved data processing and storage performance, including reducing the usage of physical resources. Those skilled in the art also will appreciate that the features described above can be combined in various ways to form multiple implementations. As a result, the invention is not limited to any specific implementation(s) described above, but only by the claims and their equivalents.

What is claimed is:

1. A method of operating a content delivery network (CDN), the method comprising:
the CDN receiving a user request;
analyzing the received user request;
classifying the received user request using a classification system comprising a first category and a second category; and
generating a first type of CDN record when the user request is classified into the first category and generating a second type of CDN record when the user request is classified into the second category.

2. The method of claim 1 wherein the first category is a bona fide request category and the second category is an attack-related request category;
further wherein generating the first type of CDN record comprises generating a full log entry comprising full data regarding CDN activity pertaining to the received user request; and
further wherein generating the second type of CDN record comprises generating an abridged log entry comprising abridged data regarding CDN activity pertaining to the received user request.

3. The method of claim 2 further comprising delivering requested content in response to the received user request only if the received user request is classified as a bona fide request.

4. The method of claim 2 wherein the received user request includes a request for content from a first content provider and further wherein the first content provider is not billed for the received user request when the received user request is classified as an attack-related request.

5. The method of claim 1 wherein the first type of CDN record comprises a log entry having a first data profile, and further wherein the second type of CDN record comprises a log entry having a second data profile.

6. The method of claim 5 wherein the first data profile comprises one or more of the following:
timestamp data;
user identification data;
cache node identification data;
origin server data;
URL identification data;
content provider identification data;
content identification data;
content size data;
content type data.

7. The method of claim 6 wherein the first category is a bona fide request category and the second category is an attack-related request category;
further wherein the received user request includes a request for content from a first content provider; and
further wherein the first content provider is not billed for the received user request when the received user request is classified as an attack-related request.

8. A method of operating a content delivery network (“CDN”), the method comprising:
the CDN receiving a plurality of user requests relating to a first content provider;
analyzing each received user request;
classifying each user request, wherein each user request is classified as one of the following:
a bona fide request; or
an attack-related request;
generating a first type of data log entry for each received user request that is classified as a bona fide request; and
generating a second type of data log entry for each received user request that is classified as an attack-related request;
generating one or more CDN-related records using one or more of the generated log entries.

9. The method of claim 8 wherein the generated one or more CDN-related records comprise billing for the first content provider, wherein the billing is based on one or more log entries of the first type and further wherein the billing excludes any charge for received user requests classified as an attack-related request.

10. A method of operating a content delivery network (CDN), the method comprising:
the CDN receiving a user request requesting content from a first content provider;
analyzing the user request;
assigning the user request to a bona fide request category or an attack-related request category;
generating a CDN log entry based on the category to which the received user request is assigned; and
generating a billing record based on one or more generated log entries based on one or more received user requests that have been classified as bona fide requests.

11. The method of claim 10 wherein the generated billing record does not include billing for any user requests classified as attack-related requests.

12. The method of claim 11 further comprising forwarding requested content in response to the received user request only when the received user request is classified as a bona fide request.
